(19) United States
(12) Patent Application Publication
(10) Pub. No.: US 2025/0054002 A1
(43) Pub. Date: Feb. 13, 2025

(54) SYSTEMS AND METHODS FOR EXTRAPOLATING FROM CRAWLED DATA TO GENERATE CLASSIFICATIONS

(71) Applicant: Acronis International GmbH, Schaffhausen (CH)

(72) Inventors: Hannes Migga-Vierke, Clinton, MA (US); Serg Bell, Costa Del Sol (SG); Stanislav Protasov, Singapore (SG)

(21) Appl. No.: 18/366,738

(22) Filed: Aug. 8, 2023

Related U.S. Application Data
(60) Provisional application No. 63/427,481, filed on Nov. 23, 2022.

(51) Int. Cl. G06Q 30/0202; G06Q 30/0251; G06V 30/413

(52) U.S. Cl. CPC G06Q 30/0202; G06Q 30/0263; G06V 30/413; G06F 16/951

(57) ABSTRACT

Disclosed herein are systems and method for extrapolating from crawled data to generate classifications. In one aspect, a method may receive an evaluation request with an input list comprising at least one entity and a respective website identifier of the at least one entity, identify, from a plurality of categorization labels, a subset of categorization labels that correspond to a requesting entity that generated the evaluation request, crawl information using the website identifier, generate at least one text body from the crawled information, apply a machine learning algorithm on the at least one text body, wherein the machine learning algorithm is configured to generate an output vector indicating categorization labels from the subset of categorization labels that the at least one entity corresponds to, based on terms in the at least one text body; and transmit the output vector to a computing device of the requesting entity.

### CROSS-REFERENCE TO RELATED APPLICATIONS

This application claims the benefit of U.S. Provisional Application No. 63/427,481, filed Nov. 23, 2022, which is herein incorporated by reference.

### FIELD OF TECHNOLOGY

The present disclosure relates to the field of machine learning, and, more specifically, to systems and methods for extrapolating from crawled data to generate classifications.

### BACKGROUND

When companies search for clients and potential partners, there is often a limited amount of information to extrapolate from and an extremely large range of possible clients/partners. A brute force approach to evaluating each prospective client/partner can take a lot of resources and time. Redirecting companies, via software, to a particular subset of clients/partners can thus be beneficial. Recommending such a subset, however, is not a trivial task. It may require a significant amount of processing, for example, to extract information about possible clients/partners and even more processing to parse the information and evaluate attributes. Due to the different amount of information for each possible client/partner, it may also be challenging being unbiased when one possible client/partner simply offers more information about themselves than others (even though that particular possible client/partner) is not a better option to pursue than others.

### SUMMARY

In one exemplary aspect, the techniques described herein relate to a method for extrapolating from crawled data to generate classifications, the method including: receiving an evaluation request with an input list including at least one entity and a respective website identifier of the at least one entity; identifying, from a plurality of categorization labels, a subset of categorization labels that correspond to a requesting entity that generated the evaluation request; crawling information from at least one website corresponding to the website identifier; generating at least one text body by parsing the crawled information; applying a machine learning algorithm on the at least one text body, wherein the machine learning algorithm is configured to generate an output vector indicating categorization labels from the subset of categorization labels that the at least one entity corresponds to, based on terms in the at least one text body; and transmitting the output vector to a computing device of the requesting entity.

In some aspects, the techniques described herein relate to a method, wherein the machine learning algorithm is further configured to: weight each term in the at least one text body based on whether the term is present in a list of critical terms for the subset of categorization labels; and determine, based on the weighted terms, whether the at least one text body corresponds to a given categorization label.

In some aspects, the techniques described herein relate to a method, wherein the machine learning algorithm is further configured to: calculate a ratio of an amount of critical terms in the at least one text body and a total amount of terms in the at least one text body and; and determine whether the at least one text body corresponds to a given categorization label further based on the ratio.

In some aspects, the techniques described herein relate to a method, wherein parsing the crawled information further includes: removing stop words and punctuation from the crawled information; and classifying, using object recognition, images from the at least one website into text describing contents of the images.

In some aspects, the techniques described herein relate to a method, wherein the evaluation request includes an evaluation type, and wherein the subset of categorization labels are further identified based on a compatibility with the evaluation type.

In some aspects, the techniques described herein relate to a method, wherein the evaluation type is one of a partner and a client.

In some aspects, the techniques described herein relate to a method, wherein a different subset of categorization labels are used for a different requesting entity.

In some aspects, the techniques described herein relate to a method, wherein crawling the information further includes utilizing a proxy service that hides an IP address of a web crawler.

In some aspects, the techniques described herein relate to a method, wherein crawling the information further includes executing a script that circumvents security measures of the at least one website.

It should be noted that the methods described above may be implemented in a system comprising at least one hardware processor and at least one memory. Alternatively, the methods may be implemented using computer executable instructions of a non-transitory computer readable medium.

In some aspects, the techniques described herein relate to a system for extrapolating from crawled data to generate classifications, the system including: at least one memory; and at least one hardware processor coupled with the at least one memory and configured, individually or in combination, to: receive an evaluation request with an input list including at least one entity and a respective website identifier of the at least one entity; identify, from a plurality of categorization labels, a subset of categorization labels that correspond to a requesting entity that generated the evaluation request; crawl information from at least one website corresponding to the website identifier; generate at least one text body by parsing the crawled information; apply a machine learning algorithm on the at least one text body, wherein the machine learning algorithm is configured to generate an output vector indicating categorization labels from the subset of categorization labels that the at least one entity corresponds to, based on terms in the at least one text body; and transmit the output vector to a computing device of the requesting entity.

In some aspects, the techniques described herein relate to a non-transitory computer readable medium storing thereon computer executable instructions for extrapolating from crawled data to generate classifications, including instructions for: receiving an evaluation request with an input list including at least one entity and a respective website identifier of the at least one entity; identifying, from a plurality of categorization labels, a subset of categorization labels that correspond to a requesting entity that generated the evaluation request; crawling information from at least one website corresponding to the website identifier; generating at least one text body by parsing the crawled information; applying a machine learning algorithm on the at least one text body, wherein the machine learning algorithm is configured to generate an output vector indicating categorization labels from the subset of categorization labels that the at least one entity corresponds to, based on terms in the at least one text body; and transmitting the output vector to a computing device of the requesting entity.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for extrapolating from crawled data to generate classifications.

FIG. 2 illustrates a flow diagram of a method for extrapolating from crawled data to generate classifications.

FIG. 3 illustrates a flow diagram of a method for determining a subset of categorization labels for a particular requesting entity.

FIG. 4 presents an example of a general-purpose computer system on which aspects of the present disclosure can be implemented.

### DETAILED DESCRIPTION

Exemplary aspects are described herein in the context of a system, method, and computer program product for extrapolating from crawled data to generate classifications. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

As described in the background, companies may seek to find clients to pitch their products to, or find partners to collaborate with. Because the list of prospective clients and partners can be exhaustive, machine learning may be used to recommend a shortlist of clients/partners. More specifically, the present disclosure executes the categorization of potential clients and partners based on the information published on their company website. For example, the website of a prospective client may indicate a size of the partner, newsletters, key values, and history. There may be certain categories that a company performing the search for a partner may look into. For example, the company may want to know if the client/partner is affiliated with a competitor, if the client/partner is affiliated with a common vendor, the type of client/partner, if the client/partner offers specific services relevant to the company, etc. Based on the data crawled from the website, the desired information may be determined and the client/partner may be categorized in various categories. When considering multiple clients/partners, the company may thus filter various categories in a user interface to identify the top clients/partners to pursue.

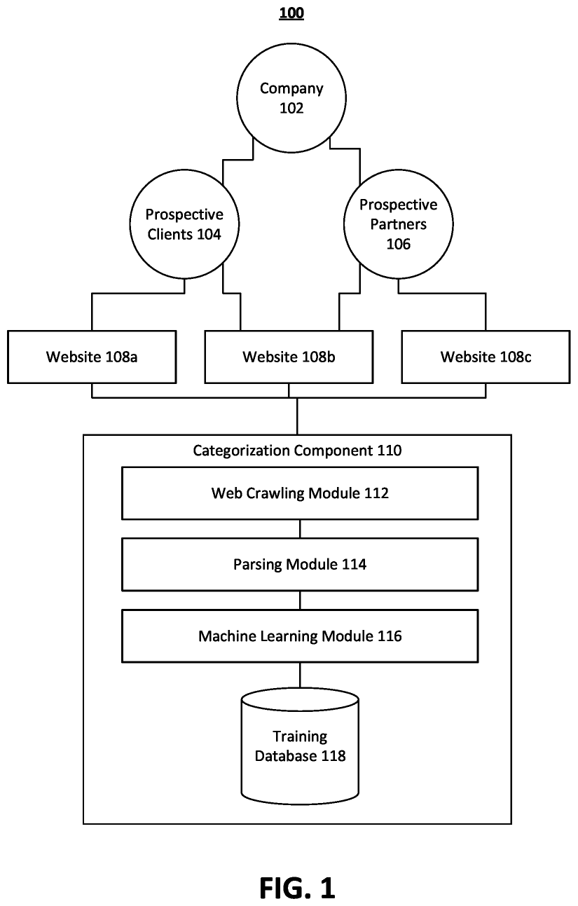

FIG. 1 is a block diagram illustrating system 100 for extrapolating from crawled data to generate classifications. For example, company 102 may be considering a plurality of prospective clients 104 and/or prospective partners 106. Each of these clients 104 and partners 106 may have their own website. Suppose that only clients are being considered. A first prospective client may have website 108a, a second prospective client may have website 108b, and a third prospective client may have website 108c.

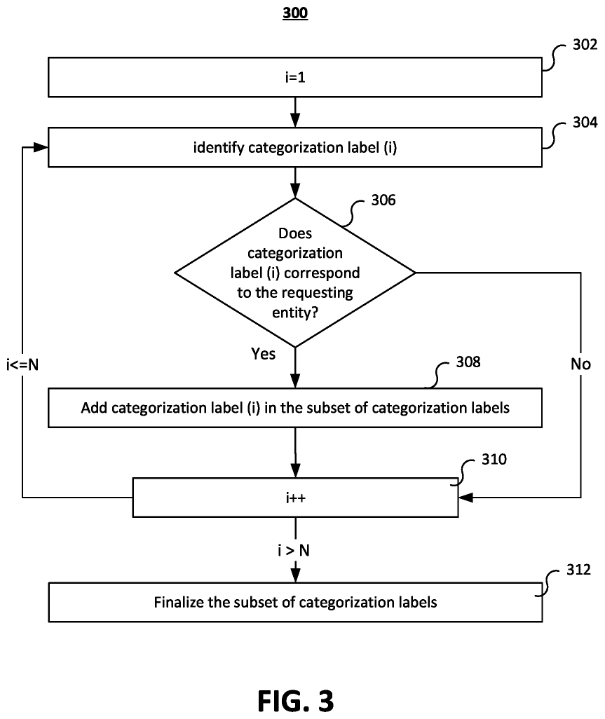

Categorization component 110 may be a software that is executed on a computer system (see FIG. 3) to implement the systems and methods of the present disclosure. There may be two aspects to categorization component 110. The first aspect involves training, using machine learning module 116, a machine learning algorithm to receive, as an input, a list of client/partner names and their associated website identifiers (e.g., URLs, social media pages, etc.) and output categorization verdicts in different categories. The second aspect involves executing the trained machine learning algorithm for any arbitrary list of clients/partners.

During the training phase, web crawling module 112 may receive URL information for a plurality of entities in training database 118. An entity may be a client or a company partner. While a client is expected to receive a product or service from the company, a company partner is expected to provide a product or service to the company. In some aspects, machine learning module 116 may train a first machine learning algorithm to categorize clients and a second machine learning algorithm to categorize partners. The following steps apply for training both algorithms.

In response to receiving URL information for the plurality of entities, web crawling module 112 may pull data from each of the websites associated with the URL information. For simplicity, for each entity, all information gathered from webpages originating from a single home page website are linked with one entity. In other words, for entity XYZ with a website www.entityXYZproducts.com, any other webpage such as www.entityXYZproducts.com/home/or www.entityXYZproducts.com/values/is still linked with entity XYZ. The different website URLs are not linked with different entities because they all stem from the same domain.

In some aspects, the website identifier may be a social media address/tag. Accordingly, web crawling module 112 may pull information from a social media presence of the targeted client/partner such as LinkedIn, Facebook, Twitter or Industry Blogs (e.g., 3rd party websites) talking about them. With this additional information, the categorization and targeting of clients/partners becomes more precise, and as such, reduces the costs for companies to market to them.

In some aspects, parsing module 114 converts crawled image-based information into a textual representation. For example, parsing module 114 may classify images and videos on the website into text using object classification-based machine learning algorithms and/or computer vision. Thus, an image of a logo of a partner/client may be converted into a name of the partner/client. In another example, a video/audio clip may reveal names of partners/clients. For example, a key person of the targeted company may be talking about an affiliation with a competitor or their offerings to their clients in the video/audio and parsing module 114 may extract the audio and convert to text. Parsing module 114 may further concatenate text strings from all web pages and converted images into one text body. This text body is used to categorize the entity.

In some aspects, parsing module 114 may apply other pre-processing techniques on the text body. For example, parsing module 114 may remove stop words that are insignificant (e.g., “the,” “is,” “a,” etc.). Parsing module 114 may translate the language of the text into a base language such as English if the website is not in the base language. Parsing module 114 may also reduce the word count to under a threshold word count (e.g., 5000).

As mentioned before, certain websites may include less information than other websites. However, the presence of less text does not necessarily mean that the prospective client/partner associated with the website is not a good match for company 102. Likewise, certain websites may be structured such that they include more graphics than text. This should also not mean that those websites should be penalized. While lesser amounts of information are not penalized, greater amounts of information should be rewarded in some aspects. Parsing module 114 may thus assign a weight to each word that is unique (e.g., appears in a global dictionary less than a threshold number of times) or to each critical term that is pre-mapped to a categorization label. For example, if a prospective client is a hosting company, a categorization label may be “is_hosting_company.” The website of the prospective client may include critical terms such as “domain name,” “host,” “websites,” etc. These critical terms are weighted higher than other terms in the crawled text body. The critical terms for each categorization label may be included in training database 118.

In some aspects, parsing module 114 may further determine the frequency of these words in the text body relative to the size of the text body. For example, if there are 400 words in the text body and 100 are critical terms of a particular categorization label, categorization component 110 may calculate that 25% of the text is geared towards the categorization label. Determining this frequency relative to the size of the text body reduces the influence of the size of text in the website. Accordingly, if another website features 100 words only and 50 words are critical terms of a particular categorization label, categorization component 110 may determine that 50% of that website is geared towards the categorization label, which exceeds the 25% of the website with 400 words. Thus, the website with only 100 words may potentially be a better client/partner candidate. The frequency value may be incorporated in training database 118 for training the machine learning algorithm.

Each categorization may be different based on the company running a search. For example, company 102 running a search may be a cyber security company that is determining whether a prospective client is already affiliated with a different cyber security company. If the company running the search is a restaurant that is determining whether a catering opportunity is present, the categorizations of the cyber security company will be irrelevant.

For example, the categorization label for the cyber security company may be:
Is_partner_Acronis
Is_partner_Datto
Is_partner_StorageCraft
Is_partner_Webroot
Is_Hoster
Is_MSP
Is_MSSP
Is_Partner_Veeam
Is_Service_Provider
Offers_Backup_and_DR
Offers_Cyber_Security
Offers_Managed_Services
   Each of these labels represents a binary query where the answer is yes or no. In other words, for a given input client/partner, the machine learning algorithm is trained to determine “yes” or “no” for each of these categorization labels. As there are multiple categories, the machine learning algorithm may be a multi-head classifier with a multi-processing pipeline.

Consider an example in which the plurality of categorization labels (i.e., all known categorization labels) includes ten labels:

| | | | | | | | | | |
|---|---|---|---|---|---|---|---|---|---|
| Label1 | Label2 | Label3 | Label4 | Label5 | Label6 | Label7 | Label8 | Label9 | Label10 |

It should be noted that the actual number of categorization labels may be significantly higher, however only ten are shown for simplicity. Categorization component 110 may determine whether each label is relevant to a particular entity (e.g., a requesting entity). For example, categorization component 110 may iterate through each label (described in FIG. 3) and output a subset of categorization labels that correspond to the requesting entity. For example, labels 1, 4, 7, 9, and 10 may correspond to an entity associated with an training vector, while other labels may not. Thus the subset of categorization labels is:

| | | | | | | | | | |
|---|---|---|---|---|---|---|---|---|---|
| Label1 | — | — | Label4 | — | — | Label7 | — | Label9 | Label10 |

During the training phase, machine learning module 116 may be provided with a plurality of entities with pre-categorized labels. Consider an example of a requesting entity named XYZ. The training vector for entity XYZ may include an input portion that comprises a text body and a vector indicating the subset of categorization labels (e.g., [1, 0, 0, 1, 0, 0, 1, 0, 1, 1] where “1” is part of the subset and “0” is not part of the subset) and an output portion comprising an output vector. The categorization labels above may be manually categorized and included in the output vector: [1, 0, 0, 2, 0, 0, 2, 0, 1, 2] (where “0” identifies a label not part of the subset, “1” is “yes,” and “2” is “no”). In a more specific example, suppose that label1 is “Is_partner_Acronis,” label4 is “Is_Hoster,” label7 is “Is_MSP,” label9 is “Offers_Backup_and_DR,” and label10 is “Offers_Cyber_Security.” The output vector not only identifies the subset of categorization labels, but also suggests the entity XYZ is a partner of Acronis, is not a hoster, is not an MSP, does offer backup and DR, and does not offer cyber security. Similarly, each other training entity has a training vector as described above, but with values specific to them. Thus, using the text body and the known output vector, machine learning module 116 trains the machine learning algorithm to generate a similar output vector for any arbitrary prospective client/partner.

Once machine learning module 116 trains the machine learning algorithm to classify the plurality of categorization labels for any arbitrary company, categorization component 110 may output, for an input list of entities, a ranked subset of entities that match the partner and/or client criteria of company 102 the most. Company 102 may use this information to generate service/marketing campaigns and offers for the partners/clients.

One of the challenges for web crawling module 112 is that some websites include security settings that prevent crawling. For example, there may be a jurisdiction lock that prevents IP addresses from outside a region (e.g., a country) from accessing the website. In another example, there may be security measures that prevent distributed denial of service (DDoS) attacks and thus block web crawling module 112. To overcome these challenges, in some aspects, categorization component 110 may use a proxy service by pretending to come from another IP address through the onion router (Tor) network. In some aspects, categorization component 110 may use JavaScript technology to overcome security questions (e.g., are you a human?).

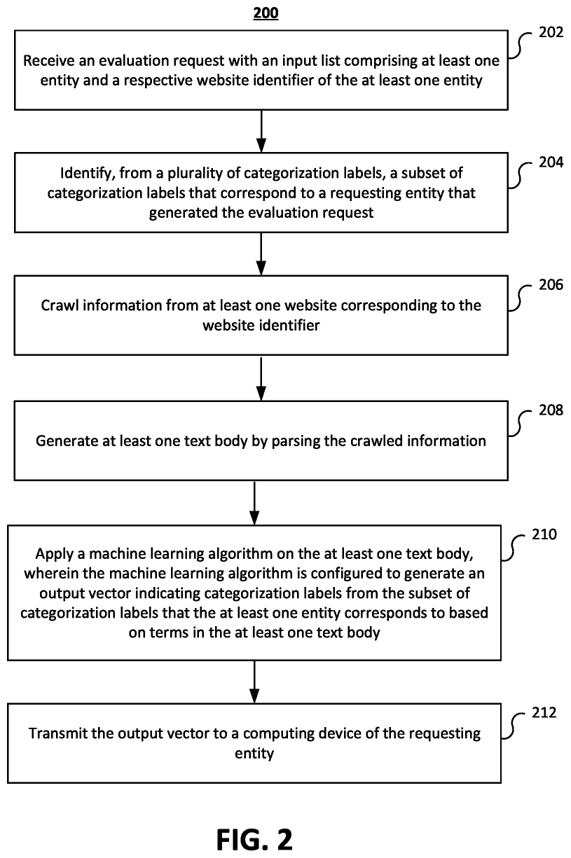

FIG. 2 illustrates a flow diagram of method 200 for extrapolating from crawled data to generate classifications.

At 202, categorization component 110 receives an evaluation request with an input list comprising at least one entity and a respective website identifier of the at least one entity. For example, a requesting entity such as a cyber security company may provide the evaluation request. The evaluation request may include website URLs of various other companies that the cyber security company is evaluating for partnership/clients.

At 204, categorization component 110 identifies, from a plurality of categorization labels, a subset of categorization labels that correspond to a requesting entity that generated the evaluation request. The subset of categorization labels is specific to the requesting entity. A different subset of categorization labels would be used for a different requesting entity. For example, categorization labels associated with cyber security may be included in the subset.

In some aspects, the evaluation request comprises an evaluation type, and the subset of categorization labels are further identified based on a compatibility with the evaluation type. For example, the evaluation type may be one of a partner and a client. Suppose that the requesting entity is partnered with ABCcompany. A categorization label for a requesting entity searching for a partner may be “is_partner_ABCcompany.” This is to establish a mutual relationship between the entity in the evaluation request and the requesting entity (i.e., both may be partners of ABCcompany).

At 206, categorization component 110 crawls information from at least one website corresponding to the website identifier. In some aspects, crawling the information further comprises utilizing a proxy service that hides an IP address of a web crawler. In other aspects, crawling the information further comprises executing a script that circumvents security measures of the at least one website.

After the categorization labels relevant to the requesting entity are identified, the information in the websites of the entities being evaluated (e.g., for a client relation, for partnership, etc.) are crawled in order to determine how the evaluated entities are classified per label. These classifications are used to identify which of the evaluated entities are most suitable as partners/clients for the requesting entity.

At 208, categorization component 110 generates at least one text body by parsing the crawled information. In some aspects, parsing the crawled information further comprises removing stop words and punctuation from the crawled information, and classifying, using object recognition, images from the at least one website into text describing contents of the images.

At 210, categorization component 110 applies a machine learning algorithm on the at least one text body, wherein the machine learning algorithm is configured to generate an output vector indicating categorization labels from the subset of categorization labels that the at least one entity corresponds to based on terms in the at least one text body.

In some aspects, categorization labels are phrased such that a “yes” is a positive connotation and “no” is a negative connotation. In other words, if the categorization label is “is_partner_acronis,” a “yes” means that there is a higher likelihood that the evaluated entity is a suitable partner for the requesting entity. Accordingly, when a respective output vector is received for each of the evaluated entities, categorization component 110 determines which of the evaluated entities are recommended to the requesting entity. In some aspects, because each of the output vectors is a collection of 1's and 0's representing yes and no, respectively, categorization component 110 may determine a sum of each output vector. Categorization component 110 may then rank each of the evaluated entities based on the summed values such that the higher sum entities are more recommendable than lower sum entities. It should be noted that categorization component 110 may apply any function (not just summation) on the values in the output vector to represent the suitability of an evaluated entity. In some aspects, the recommendation is generated based on whether the result of the function exceeds a threshold value. For example, if a function is applied on the output vector that results in the value 50, and if the threshold value is 60, because categorization component 110 determines that 50 is less than 60, the recommendation is not offer a partnership/client relation.

The recommendations may be used to create campaigns with specific messaging. For example, if the requested entity is partnered with company X, the recommendation may be to establish a partnership with company Y instead.

In some aspects, the results of the evaluation request (including the recommendation and/or rankings) are presented on a graphical user interface through which the evaluation request was received. In the event that only one entity is requested for evaluation, the results may include a recommendation (i.e., do not offer partnership, offer partnership) based on whether the amount of categorization labels. In some aspects, categorization component 110 may transmit a recommendation to a computing device of the requesting entity (e.g., via an email or text).

In some aspects, wherein the machine learning algorithm is further configured to weight each term in the at least one text body based on whether the term is present in a list of critical terms for the subset of categorization labels, and determine, based on the weighted terms, whether the at least one text body corresponds to a given categorization label.

In some aspects, the machine learning algorithm is further configured to calculate a frequency of critical terms by calculating a ratio of a total amount of terms in the at least one text body and an amount of critical terms in the at least one text body, and determine whether the at least one text body corresponds to a given categorization label based on the frequency.

At 212, categorization component 110 transmits the output vector to a computing device of the requesting entity.

FIG. 3 illustrates a flow diagram of method 300 for determining a subset of categorization labels for a particular requesting entity. At 302, the variable i is set to 1. At 304, from a plurality of categorization labels, categorization component 110 identifies the ith categorization label (e.g., the 1^{st}). Categorization component 110 then begins to iterate through each of the plurality of categorization labels to identify a subset that corresponds to the requesting entity.

In some aspects, each categorization label may have a predetermined label type and a label sub-type. For example, when the categorization label is made by a developer/user, the developer/user may assign a label type (e.g., partner, client, etc.) that indicates whether the label is used to evaluate for partnership, client relations, etc. When checking for correspondence between the requesting entity and the categorization label, the label type is compared with the evaluation type (i.e., is the requesting entity looking for a partner or client). The label sub-type may indicate which industry the categorization label corresponds to. For example, the label sub-type may be cyber security, medical, auto, biology, etc. When checking for correspondence between the requesting entity and the categorization label, categorization component 110 may determine whether the industry of the requesting entity matches the label sub-type. In some aspects, the industry of the requesting entity is provided in the evaluation request. In some aspects, categorization component 110 may run an industry classification algorithm (trained by machine learning module 116) that receives crawled information from website(s) associated with the requesting entity and outputs an industry. A categorization label corresponds to the requesting entity when both label type and label sub-type match the evaluation type and industry, respectively.

For example, at 306, categorization component 110 determines whether the ith categorization label corresponds to the requesting entity. Suppose that the requesting entity is a cyber security company. The ith categorization label may be “Is_partner_Acronis.”

In response to determining that the ith categorization label corresponds to the requesting entity, method 300 advances to 308, where categorization component 110 adds the ith categorization label in the subset of categorization labels specific to the requesting entity. If the correspondence does not exist, method 300 advances to 310, where i is incremented by 1. Likewise, after updating the subset at 308, method 300 advances to 310.

From 310, method 300 returns to 304 if the value of i is less than or equal to the total number N of categorization labels (i.e., the next categorization label is considered in the subsequent loop). However, if i is greater than N, method 300 ends at 312, where categorization component 110 finalizes the subset of categorization labels (i.e., no other categorization labels left to consider).

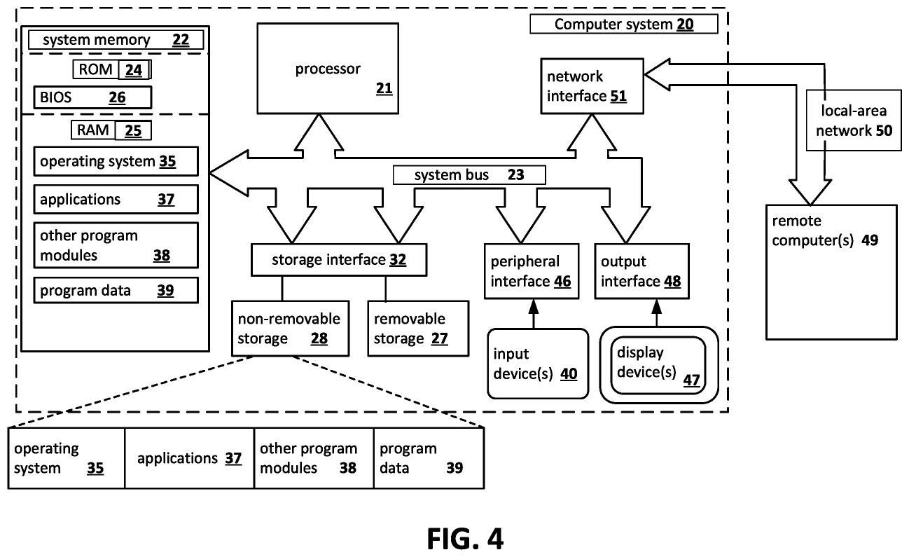

FIG. 4 is a block diagram illustrating a computer system 20 on which aspects of systems and methods for extrapolating from crawled data to generate classifications may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-3 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for extrapolating from crawled data to generate classifications, the method comprising:
receiving an evaluation request with an input list comprising at least one entity and a respective website identifier of the at least one entity;
identifying, from a plurality of categorization labels, a subset of categorization labels that correspond to a requesting entity that generated the evaluation request;
crawling information from at least one website corresponding to the website identifier;
generating at least one text body by parsing the crawled information;
applying a machine learning algorithm on the at least one text body, wherein the machine learning algorithm is configured to generate an output vector indicating categorization labels from the subset of categorization labels that the at least one entity corresponds to, based on terms in the at least one text body; and
transmitting the output vector to a computing device of the requesting entity.

2. The method of claim 1, wherein the machine learning algorithm is further configured to:
weight each term in the at least one text body based on whether the term is present in a list of critical terms for the subset of categorization labels; and
determine, based on the weighted terms, whether the at least one text body corresponds to a given categorization label.

3. The method of claim 1, wherein the machine learning algorithm is further configured to:
calculate a ratio of an amount of critical terms in the at least one text body and a total amount of terms in the at least one text body and; and
determine whether the at least one text body corresponds to a given categorization label further based on the ratio.

4. The method of claim 1, wherein parsing the crawled information further comprises:
removing stop words and punctuation from the crawled information; and
classifying, using object recognition, images from the at least one website into text describing contents of the images.

5. The method of claim 1, wherein the evaluation request comprises an evaluation type, and wherein the subset of categorization labels are further identified based on a compatibility with the evaluation type.

6. The method of claim 5, wherein the evaluation type is one of a partner and a client.

7. The method of claim 1, wherein a different subset of categorization labels are used for a different requesting entity.

8. The method of claim 1, wherein crawling the information further comprises utilizing a proxy service that hides an IP address of a web crawler.

9. The method of claim 1, wherein crawling the information further comprises executing a script that circumvents security measures of the at least one website.

10. A system for extrapolating from crawled data to generate classifications, the system comprising:
at least one memory; and
at least one hardware processor coupled with the at least one memory and configured, individually or in combination, to:
receive an evaluation request with an input list comprising at least one entity and a respective website identifier of the at least one entity;
identify, from a plurality of categorization labels, a subset of categorization labels that correspond to a requesting entity that generated the evaluation request;
crawl information from at least one website corresponding to the website identifier;
generate at least one text body by parsing the crawled information;
apply a machine learning algorithm on the at least one text body, wherein the machine learning algorithm is configured to generate an output vector indicating categorization labels from the subset of categorization labels that the at least one entity corresponds to, based on terms in the at least one text body; and
transmit the output vector to a computing device of the requesting entity.

11. The system of claim 10, wherein the machine learning algorithm is further configured to:
weight each term in the at least one text body based on whether the term is present in a list of critical terms for the subset of categorization labels; and
determine, based on the weighted terms, whether the at least one text body corresponds to a given categorization label.

12. The system of claim 10, wherein the machine learning algorithm is further configured to:
calculate a ratio of an amount of critical terms in the at least one text body and a total amount of terms in the at least one text body and; and
determine whether the at least one text body corresponds to a given categorization label further based on the ratio.

13. The system of claim 10, wherein the at least one hardware processor is configured to parse the crawled information by:
removing stop words and punctuation from the crawled information; and
classifying, using object recognition, images from the at least one website into text describing contents of the images.

14. The system of claim 10, wherein the evaluation request comprises an evaluation type, and wherein the subset of categorization labels are further identified based on a compatibility with the evaluation type.

15. The system of claim 14, wherein the evaluation type is one of a partner and a client.

16. The system of claim 10, wherein a different subset of categorization labels are used for a different requesting entity.

17. The system of claim 10, wherein the at least one hardware processor is configured to crawl the information by utilizing a proxy service that hides an IP address of a web crawler.

18. The system of claim 10, wherein the at least one hardware processor is configured to crawl the information by executing a script that circumvents security measures of the at least one website.

19. A non-transitory computer readable medium storing thereon computer executable instructions for extrapolating from crawled data to generate classifications, including instructions for:
receiving an evaluation request with an input list comprising at least one entity and a respective website identifier of the at least one entity;
identifying, from a plurality of categorization labels, a subset of categorization labels that correspond to a requesting entity that generated the evaluation request;
crawling information from at least one website corresponding to the website identifier;
generating at least one text body by parsing the crawled information;
applying a machine learning algorithm on the at least one text body, wherein the machine learning algorithm is configured to generate an output vector indicating categorization labels from the subset of categorization labels that the at least one entity corresponds to, based on terms in the at least one text body; and
transmitting the output vector to a computing device of the requesting entity.
